(19) United States
(12) Patent Application Publication
(10) Pub. No.: US 2012/0287305 A1
(43) Pub. Date: Nov. 15, 2012

(54) IMAGING DEVICE, REPRODUCTION DEVICE AND IMAGE REPRODUCTION PROGRAM

(75) Inventor: Koji OZAKI, Yokohama-shi (JP)

(73) Assignee: NIKON CORPORATION, Tokyo (JP)

(21) Appl. No.: 13/557,461

(22) Filed: Jul. 25, 2012

Related U.S. Application Data
(63) Continuation of application No. 12/458,725, filed on Jul. 21, 2009.

(30) Foreign Application Priority Data
Jul. 22, 2008 (JP) 2008-188250
Jun. 26, 2009 (JP) 2009-151848

(51) Int. Cl. H04N 5/225; H04N 5/76

(52) U.S. Cl. 348/231.99; 348/333.08; 348/E05.025; 348/E05.031

(57) ABSTRACT

An imaging device comprises: a mount unit at which an optical system can be mounted; a detection unit that detects disengagement of the optical system from the mount unit; an imaging unit that captures a subject image formed via the optical system mounted at the mount unit and outputs image signals; a display unit at which an image is brought up on display based upon the image signals output from the imaging unit; and a control unit that prohibits display of the image at the display unit, the image being based upon the image signals output from the imaging unit after the detection unit detects disengagement of the optical system.

### INCORPORATION BY REFERENCE

This is a Continuation of application Ser. No. 12/458,725 filed Jul. 21, 2009. The disclosure of the prior application is hereby incorporated by reference herein in its entirety. The disclosure of the following priority applications are herein incorporated by references Japanese Patent Application No. 2008-188250 filed Jul. 22, 2008; Japanese Patent Application NO. 2009-151848 filed Jun. 26, 2009.

### BACKGROUND OF THE INVENTION

1. Field of the Invention

The present invention relates to an imaging device, a reproduction device and an image reproduction program.

2. Description of Related Art Japanese Laid Open Patent Publication No. S59-201029 discloses an imaging device embodied as a single-lens reflex electronic camera. As the photographer switches a still image/movie image selector switch of the electronic camera to the movie shooting setting, a still/movie switching circuit is engaged in switchover processing so as to control internal mechanisms such as a shutter drive device in a movie shooting mode and a movie image constituted with successive still images is obtained. The movie image thus obtained is stored into a storage device in the electronic camera body.

Japanese Laid Open Patent Publication No. 2005-124045 discloses a camera equipped with a display unit at which a photographic image is displayed, mounted at the rear surface of the casing. At this camera, image data are generated based upon electrical imaging signals output from an image sensor and an image based upon the generated image data is brought up on display at the display unit. A movie image such as that obtained at the single-lens reflex electronic camera described above, too, can normally be displayed at this type of display unit.

### SUMMARY OF THE INVENTION

The single-lens reflex electronic camera disclosed in Japanese Laid Open Patent Publication No. S59-201029 allows an interchangeable photographic lens to be mounted at the body. The photographer is thus able to choose the optimal photographic lens among a plurality of interchangeable photographic lenses with varying focal lengths and the like and mount the selected photographic lens at the body.

However, if the photographer shooting a movie image, which is displayed at the display unit in real-time, replaces the photographic lens without discontinuing the movie shooting operation, an interruption in which no subject image is formed on the imaging surface of the image sensor, will occur. Under these circumstances, a problem arises in that the movie image on display at the display unit becomes unstable.

According to the 1st aspect of the present invention, an imaging device comprises: a mount unit at which an optical system can be mounted; a detection unit that detects disengagement of the optical system from the mount unit; an imaging unit that captures a subject image formed via the optical system mounted at the mount unit and outputs image signals; a display unit at which an image is brought up on display based upon the image signals output from the imaging unit; and a control unit that prohibits display of the image at the display unit, the image being based upon the image signals output from the imaging unit after the detection unit detects disengagement of the optical system.

According to the 2nd aspect of the present invention, in the imaging device according to the 1st aspect is claim 1, it is preferred that the detection unit also detects engagement of the optical system at the mount unit; and if the detection unit detects engagement of the optical system while display of the image based upon the image signal at the display unit is prohibited, the control unit issues permission for displaying at the display unit an image that is based upon the image signals output from the imaging unit after engagement of the optical system is detected.

According to the 3rd aspect of the present invention, in the imaging device according to the 1st aspect, it is preferred that if the detection unit detects disengagement of the optical system, the control unit executes control so as to display a specific image at the display unit.

According to the 4th aspect of the present invention, the imaging device according to the 3rd aspect preferably further comprises: a temporary storage unit where image signals output from the imaging unit are temporarily stored, and in the imaging device the control unit executes control so as to display at the display unit an image based upon image signals as the specific image, the image signals having been stored into the temporary storage unit before the detection unit detects disengagement of the optical system.

According to the 5th aspect of the present invention, the imaging device according to the 1st aspect preferably further comprises: a recording control unit that records image signals output from the imaging unit into a storage medium as first movie image data, and in the imaging device the recording control unit prohibits recording at the storage medium of image signals that are output from the imaging unit after the detection unit detects disengagement of the optical system.

According to the 6th aspect of the present invention, in the imaging device according to the 5th aspect, it is preferred that the detection unit also detects engagement of the optical system at the mount unit; and if the detection unit detects engagement of the optical system while recording at the storage medium of the image signals output from the imaging unit is prohibited, the recording control unit records into the storage medium image signals as second movie image data, the image signal being output from the imaging unit after engagement of the optical system is detected.

According to the 7th aspect of the present invention, in the imaging device according to the 6th aspect, it is preferred that the recording control unit records the first movie image data and the second movie image data into a single image file.

According to the 8th aspect of the present invention, in the imaging device according to the 6th aspect, it is preferred that the recording control unit records the first movie image data and the second movie image data into separate image files.

According to the 9th aspect of the present invention, an imaging device comprises: a mount unit at which an optical system can be mounted; a detection unit that detects engagement of the optical system at the mount unit; an imaging unit that captures a subject image formed via the optical system mounted at the mount unit and outputs image signals; a display unit at which an image is brought up on display based upon image signals output from the imaging unit; and a control unit that brings up on display at the display unit an image based upon the image signals output from the imaging unit, when the detection unit detects engagement of the optical system.

According to the 10th aspect of the present invention, a reproduction device comprises: an input unit that takes in movie image data having been obtained at an imaging device; a display unit at which a movie image corresponding to the movie image data input via the input unit is displayed; a detection unit that detects movie image data among the input movie image data as disengagement-period data, the movie image data being obtained at the imaging device while no optical system was present at a mount unit of the imaging device; and a control unit that prohibits display at the display unit of a movie image corresponding to the disengagement-period data if the detection unit detects the disengagement-period data.

According to the 11th aspect of the present invention, in the reproduction device according to the 10th aspect, it is preferred that the control unit brings up on display at the display unit a movie image corresponding to image data included in the movie image data input via the input unit, the image data being obtained after acquisition of the disengagement-period data detected by the detection unit.

According to the 12th aspect of the present invention, in the reproduction device according to the 11th aspect, it is preferred that the control unit brings up on display at the display unit movie image corresponding to movie image data included in the movie image data input via the input unit as a seamless movie sequence, the movie image data excluding the disengagement-period data detected by the detection unit.

According to the 13th aspect of the present invention, a computer-readable recording medium on which an image reproduction program that is executed by a computer is recorded, and the image reproduction program comprises: an input procedure through which movie image data obtained at an imaging device are input; a display procedure through which a movie image corresponding to the movie image data having been input is brought up on display at a display unit; a detection procedure through which movie image data included in the input movie image data are detected as disengagement-period data, the movie image data being obtained at the imaging device while no optical system was mounted at a mount unit of the imaging device; and a control procedure through which display at the display unit of a movie image corresponding to the disengagement period data is prohibited if the disengagement-period data are detected.

### BRIEF DESCRIPTION OF THE DRAWINGS

FIGS. 1A and 1B each provide an external view of the digital camera achieved in an embodiment, with FIG. 1A presenting a perspective of the front side and FIG. 1B presenting a rear view;

FIG. 2 is a schematic block diagram showing the structure adopted in the digital camera shown in FIGS. 1A and 1B;

FIG. 3 presents a schematic flowchart of the movie shooting processing executed by the control unit when the movie shooting mode is selected in response to an operation of the photographing mode dial;

FIGS. 4A and 4B illustrate the image data stored in the buffer memory;

FIG. 5 presents a schematic flowchart of the movie shooting processing executed in a variation of the present invention;

FIG. 6 is a schematic block diagram showing the structure adopted in the reproduction device achieved in an embodiment of the present invention; and

FIG. 7 illustrates the overall configuration of a system through which the program product is provided.

### DESCRIPTION OF PREFERRED EMBODIMENT

A preferred embodiment of the imaging device according to the present invention is now described in reference to an example in which the present invention is adopted in a digital camera.

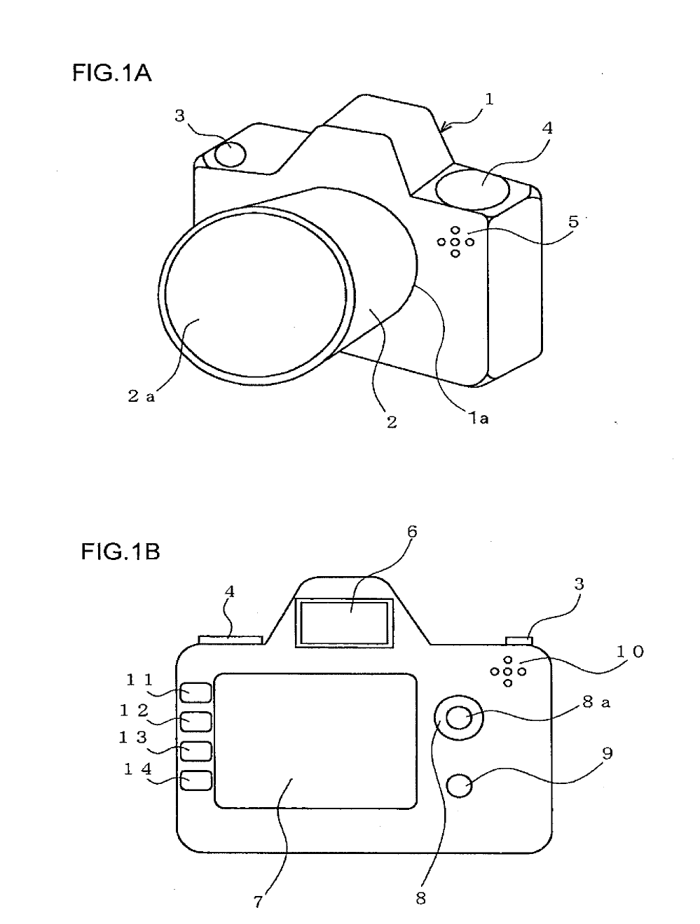

FIGS. 1A and 1B each provide an external view of a digital camera 1 achieved in the embodiment, with FIG. 1A presenting a perspective of the front side and FIG. 1B presenting a rear view.

As shown in FIG. 1A, a lens unit 2 that includes a lens 2a via which light originating from a subject is guided into the camera is mounted at the center of the front surface of the digital camera 1. The lens unit 2 is an interchangeable lens that is mounted at the body of the digital camera 1 as it is screwed into a lens mount (threaded opening) 1a at the body of the digital camera 1. The lens mount 1a constitutes a mount unit at which a lens unit 2, i.e., an optical system, can be mounted. The lens unit 2 can be disengaged from the lens mount 1a by operating a lens release button (not shown) disposed at a side of the lens mount 1a. A contact point via which the lens unit 2 and the body of the digital camera 1 become electrically connected is located at the lens mount 1a.

When a lens unit 2 is mounted, a pin terminal (not shown) located at an end of the lens unit 2 connects with the contact point located at the lens mount 1a and thus the lens unit 2 and the body of the digital camera 1 become electrically connected with each other. A shutter button 3, which is operated to take a picture, is disposed at the upper surface of the digital camera 1. In addition, a photographing mode dial 4 operated to select a specific photographing mode, such as a distance shooting mode, a close-up shooting mode or a movie shooting mode, is disposed on the right side at the upper surface of the digital camera 1. A microphone 5 that picks up sound and the like, to be recorded together with the movie image during a movie shooting operation, is disposed at the front surface of the body of the digital camera 1.

As shown in FIG. 1B, over an upper area of the rear surface of the digital camera 1, an optical viewfinder 6, through which a photographic subject being photographed can be viewed, is disposed. A rear-side monitor 7, at which various types of information related to photographing operation, a photographic image or the like is displayed, is disposed below the optical viewfinder.

To the right of the rear-side monitor 7, a ring-shaped multi-selector 8 is disposed, and a confirm button 8a, operated to confirm selection of an item having been chosen via the multi-selector 8, is disposed in the area enclosed by the multi-selector 8. Below the multi-selector 8, a delete button 9 operated to delete image data resulting from photographing operation or the like is disposed. In addition, a speaker 10 via which recorded sound or the like is output is disposed to the right of the multi-selector 8.

To the left of the rear-side monitor 7, a reproduce button 11, a menu button 12, a reduce/thumbnail button 13 and an enlarge button 14 are disposed. The reproduce button 11 is operated to reproduce a photographed image and display the reproduced image at the rear-side monitor 7. The menu button 12 is operated to bring up on display a menu screen in which various settings can be selected for the digital camera 1. The reduce/thumbnail button 13 is operated to bring up a reduced display of a photographic image or a thumbnail display at the rear-side monitor 7. The enlarge button 14 is operated to bring up an enlarged display of a photographic image or the like.

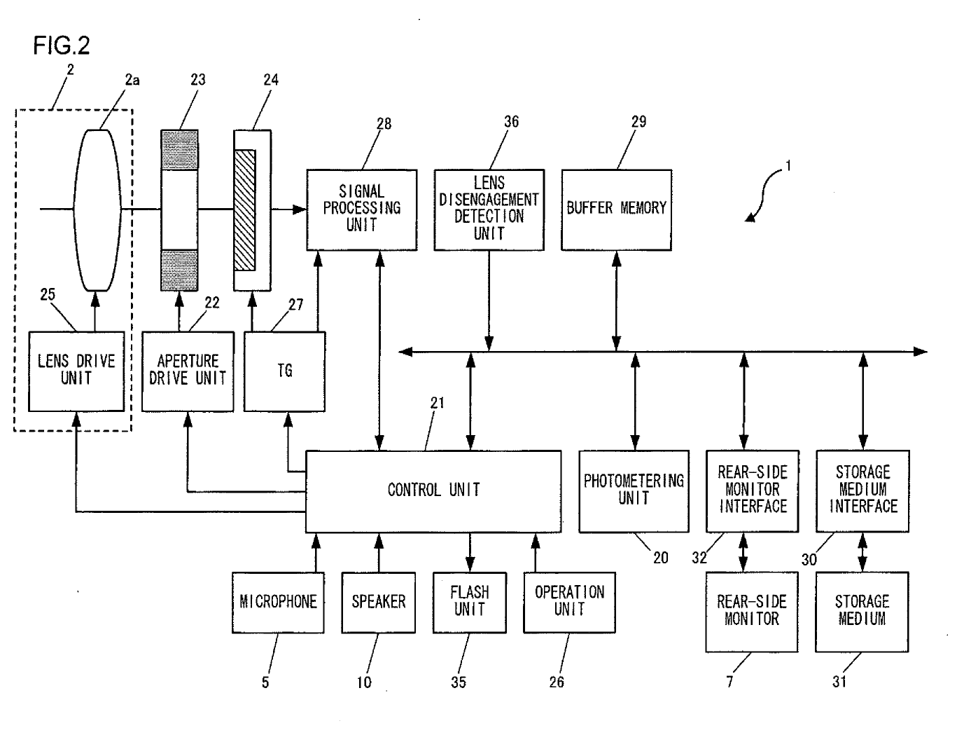

FIG. 2 is a schematic block diagram showing the structure adopted in the digital camera 1. It is to be noted that in FIG. 2, the same reference numerals are assigned to units identical to those described in reference to FIGS. 1A and 1B.

The quantity of subject light having passed through the lens 2a is detected at a photometering unit 20. A control unit 21 controls the drive of an aperture drive unit 22 based upon the subject light quantity detected at the photometering unit 20. Consequently, the degree of opening at an aperture 23 is adjusted via the aperture drive unit 22 and the amount of light in the subject image projected onto an image sensor 24 constituted with a CCD (charge coupled device) sensor or the like is controlled. The image sensor 24 constitutes an imaging unit that captures the subject image formed via a lens unit 2 mounted at the lens mount 1a.

The control unit 21 outputs a drive signal to a lens drive unit 25 via the contact point at the lens mount 1a and the pin terminal at the lens unit 2 mentioned earlier. The lens drive unit 25 is constituted with a CPU (central processing unit), a motor and the like built into the lens unit 2. Based upon the drive signal input thereto, the lens drive unit 25 drives the lens 2a along the optical axis so as to adjust the focus of the subject image projected onto the image sensor 24.

The control unit 21, which includes an internal memory with a program based upon which the digital camera 1 is controlled and the like recorded therein and a CPU (neither shown), executes various types of specific arithmetic operations in conformance to the program recorded in the internal memory to control various circuits within the digital camera 1. In response to an operation of the shutter button 3 mentioned earlier, constituting part of an operation unit 26, the image sensor 24 captures an image formed with the subject light having passed through the lens 2a and the aperture 23. It is to be noted that the operation unit 26 includes the photographing mode dial 4, the multi-selector 8 and the various buttons 9˜14 described earlier, as well as the shutter button 3. A flash unit 35 emits illuminating light used to illuminate the subject when the surrounding environment is dark, either in response to an operation at the operation unit 26 or automatically.

The timing with which the electrical charges having accumulated at the image sensor 24 are output to a signal processing unit 28 where they are processed as imaging signals (image signals) is regulated by a timing pulse generated at a timing generator (TG) 27. The signal processing unit 28 executes a specific type of analog signal processing on the imaging signals input thereto, converts the imaging signals having undergone the analog signal processing to digital signals and outputs the digital signals to the control unit 21. The control unit 21 generates image data by executing specific image processing such as white balance processing and gamma correction on the image signals input thereto. Subsequently, the control unit 21 temporarily stores the image data resulting from the image processing into a buffer memory 29 constituted with a storage memory and also records the image data into a storage medium 31 constituted with a non-volatile memory via a storage medium interface 30.

The buffer memory 29 is a storage unit where image data having been generated based upon image signals resulting from an imaging operation executed at the image sensor 24 are temporarily stored. Image data corresponding to a plurality of frames of images having been captured at the image sensor 24 are stored in the buffer memory 29. The storage medium 31 constitutes a recording unit where image data generated based upon image signals resulting from an imaging operation executed at the image sensor 24 are recorded. In addition, the control unit 21 records audio data collected via the microphone 5 during a movie shooting operation into the storage medium 31 via the storage medium interface 30. When a photographic image is to be reproduced, the corresponding image data and audio data stored in the storage medium 31 are read out by the control unit 21 via the storage medium interface 30 and are stored into the buffer memory 29.

Under control executed by the control unit 21, the image data stored in the buffer memory 29 are converted via a rear-side monitor interface 32 to display image data matching the resolution at the liquid crystal device constituting the rear-side monitor 7 and a still image or a movie image constituted with the display image data is brought up on display at the rear-side monitor 7. The rear-side monitor 7 is a display unit at which still images and movie images are brought up on display based upon image signals resulting from an imaging operation executed at the image sensor 24. In addition, under control executed by the control unit 21, the audio data stored in the buffer memory 29 are output through the speaker 10 as accompanying sound, background sound or the like.

The digital camera 1 includes a lens disengagement detection unit 36 that detects the absence of a lens unit 2, having been disengaged from the lens mount 1a in response to an operation of the lens release button mentioned earlier. The lens disengagement detection unit 36, constituted with the contact point that links with the pin terminal at a lens unit 2, is a detection unit that detects the presence/absence of a lens unit 2 at the lens mount 1a. The control unit 21 and the lens drive unit 25 together constitute a communication means for enabling communication between a lens unit 2 mounted at the lens mount 1a and the body of the digital camera 1 via the pin terminal and the contact point described above. While the pin terminal and the contact point are connected with each other, i.e., while communication via the communication means is enabled, the lens disengagement detection unit 36 outputs an engagement detection signal indicating that a lens unit 2 is currently mounted at the lens mount 1a. As the lens unit 2 is disengaged from the lens mount 1a and thus the pin terminal and the contact point become disconnected from each other, the communication via the communication means is disabled. As soon as the communication via the communication means is disabled, the lens disengagement detection unit 36 detects disengagement (absence) of the lens unit 2 from the lens mount 1a and outputs a disengagement detection signal indicating that the lens unit 2 has been disengaged, to the control unit 21.

Under control executed by the control unit 21 and the rear-side monitor interface 32, a movie image is brought up on display at the rear-side monitor based upon image signals obtained via the image sensor 24. Under control executed by the control unit 21 and the storage medium interface 30, image data (movie image data) generated based upon image signals obtained at the image sensor 24 are recorded into the storage medium 31. In the movie shooting mode, the control unit 21 in the embodiment prohibits display at the rear-side monitor 7 of an image based upon image signals expressing an image captured at the image sensor 24 after the lens disengagement detection unit 36 detects disengagement of the lens unit 2 from the lens mount 1a. The control unit 21 executes control so that a specific image is displayed at the rear-side monitor 7. In addition, the control unit 21 executes control in the movie shooting mode so as to prohibit recording at the storage medium 31 of image data based upon image signals expressing an image captured at the image sensor 24 after the lens disengagement detection unit 36 detects disengagement of the lens unit 2 from the lens mount 1a. It is to be noted that when no lens unit 2 is present at the lens mount 1a, no subject image is formed at the image sensor 24 and thus, signals output from the image sensor 24 in this state do not hold any information related to the subject. However, such signals, which do not contain subject-related information, will also be referred to as image signals in the following description.

As a lens unit 2 is mounted at the lens mount 1a while display of the movie image based upon image signals obtained at the image sensor 24 is prohibited at the rear-side monitor 7 and recording of the movie image data into the storage medium 31 is also prohibited, the control unit 21 issues a permission to display the movie image at the rear-side monitor 7 and record the movie image data into the storage medium 31. In other words, the control unit 21 executes control so as to display at the rear-side monitor 7 the movie image generated based upon image signals obtained at the image sensor 24 after an engagement detection signal from the lens disengagement detection unit 36 is input thereto. In addition, the control unit 21 executes control via the storage medium interface 30 so as to record into the storage medium 31 the movie image data generated based upon the image signals obtained at the image sensor 24.

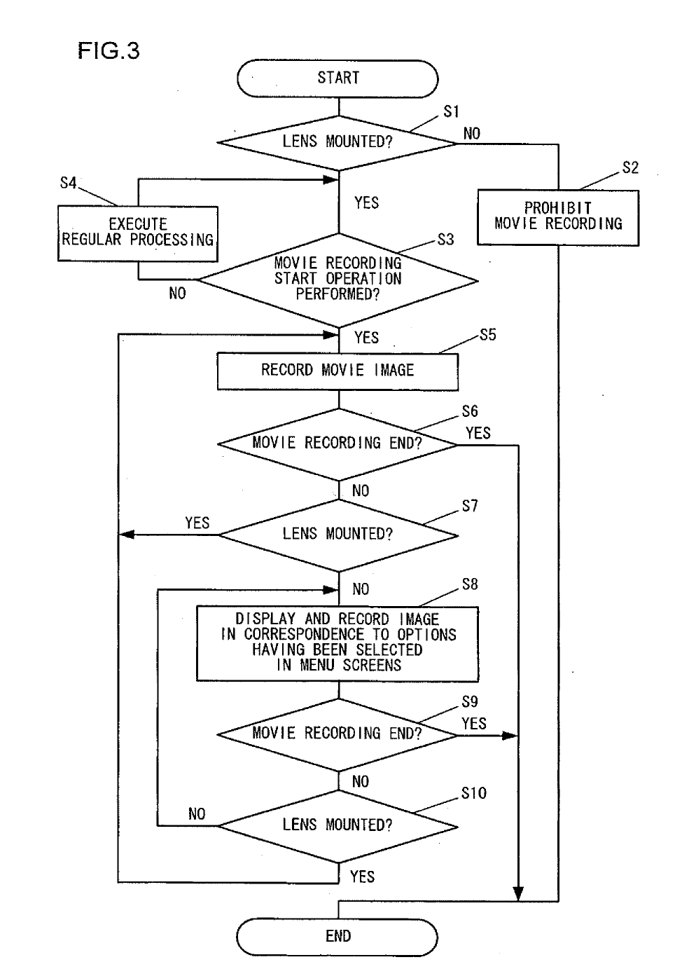

FIG. 3 presents a schematic flowchart of the movie shooting processing executed by the control unit 21 when the movie shooting mode is selected via the photographing mode dial 4.

The photographer is able to preselect settings related to image display and image data recording to come into effect in the event of disengagement of the lens unit 2 while a movie shooting operation is in progress prior to the execution of the movie shooting processing. The photographer selects desired settings from among a plurality of setting menu options brought up on display at the rear-side monitor 7 in response to an operation of the menu button 12. The setting menu options are listed in a display setting menu related to image display at the rear-side monitor 7 and a recording setting menu related to image data recording of image data temporarily stored in the buffer memory 29 into the storage medium 31.

The following four options, for instance, may be listed in the display setting menu.

(1-1) A menu option for holding on display at the rear-side monitor 7 a specific image, which corresponds to the image data (most recently obtained data) expressing the image obtained immediately before the lens unit 2 is disengaged, among sets of image data corresponding to the plurality of images temporarily stored in the buffer memory 29

(1-2) A menu option for holding on display at the rear-side monitor 7 a specific image, which corresponds to image data recorded in advance in the internal memory where the program and the like are recorded (e.g., a black image used to display the entire screen of pure black)

(1-3) A menu option for holding on display at the rear-side monitor 7 a specific image that corresponds to a set of image data preselected by the user among sets of image data already recorded in the storage medium 31

(1-4) A menu option for holding on display at the rear-side monitor 7 a specific image indicating that the lens unit 2 has been disengaged with a message “lens being replaced” or the like

The recording setting menu may include the following two options.

(2-1) A menu option for recording into the storage medium 31 specific image data selected in the display setting menu, in place of the image data obtained during the absence of a lens unit 2

(2-2) A menu option for not recording into the storage medium 31 any image data obtained during the absence of a lens unit 2

The user is able to individually select a specific image data display setting and a specific image data recording setting by choosing desirable menu options in the setting menus as described above.

As the photographer selects the movie shooting mode by operating the photographing mode dial 4, the control unit 21 starts the movie shooting processing. It is to be noted that the control unit 21 executes the program enabling the movie shooting processing in FIG. 3, which is recorded in advance in a memory or the like (not shown) within the control unit 21.

Based upon a detection signal provided from the lens disengagement detection unit 36, the control unit 21 makes a decision as to whether or not a lens unit 2 is mounted at the lens mount 1a at the body of the digital camera 1 (see S1 in FIG. 3). If no lens unit 2 is mounted at the lens mount 1a, i.e., if the decision results indicate “NO”, the control unit 21 executes processing for prohibiting movie recording into the storage medium 31 (S2). Namely, the control unit 21 brings up a display on the rear-side monitor 7 indicating that movie shooting is currently prohibited, before ending the movie shooting processing. If, on the other hand, a lens unit 2 is mounted at the mount unit 1a and thus, the results of the decision made in S1 indicate “YES”, the control unit 21 makes the decision as to whether or not a movie recording start operation has been performed, i.e., whether or not the shutter button 3 has been operated in order to start recording the movie image (S3). If the results of this decision indicate “NO”, the control unit 21 executes regular processing (S4), other than processing for taking in the subject image projected at the image sensor 24, and subsequently repeatedly executes the decision-making processing in S3.

As the photographer operates the shutter button. 3 and an affirmative (“YES”) decision is made in S3, the control unit 21 starts recording the movie image. In this situation, the control unit 21 executes processing for displaying at the rear-side monitor 7 an image (live image) with low resolution, used to allow the photographer to visually check the image corresponding to the image data having been taken in. In addition, the control unit 21 executes processing (S5) for recording the image data obtained through the movie shooting operation, into the storage medium 31 as movie image data. The control unit 21 then makes a decision as to whether or not the movie recording operation is to end, i.e., whether or not the photographer has operated the shutter button 3 again in order to end the movie recording operation (S6). If the results of this decision indicate “YES”, the control unit 21 ends the movie shooting processing.

If, on the other hand, the shutter button 3 has not been operated and a negative (“NO”) decision is made in S6, the control unit 21 makes a decision (S7) based upon the detection signal provided from the lens disengagement detection unit 36 as to whether or not a lens unit 2 is mounted. This decision-making step is executed in order to determine whether or not the lens unit 2 has been disengaged from the lens mount 1a for a replacement or the like while the movie recording operation is in progress. If a lens unit 2 is present at the lens mount an affirmative (“YES”) decision is made in step S7 accordingly, the processing returns to S5 so as to allow the control unit 21 to continue recording the movie image. If, on the other hand, the lens unit 2 has been disengaged from the lens mount 1a while the movie recording operation is in progress, i.e., if a negative (“NO”) decision is made in S7, the control unit 21 displays an image and records image data (S8), as indicated in the settings having been selected in advance in the display setting menu and the recording setting menu as explained earlier. Namely, based upon the menu option selected in the display setting menu, the image corresponding to the most recently obtained data, a black image or the like, is brought up on display as the specific image at the rear-side monitor 7. In addition, if the menu option (2-1) for recording specific image data has been selected in the recording setting menu, specific image data corresponding to the setting selected in the display setting menu are recorded into the storage medium 31. While the processing in S8 described above is in progress, the control unit 21 continuously records the sound being picked up via the microphone 5 without interruption.

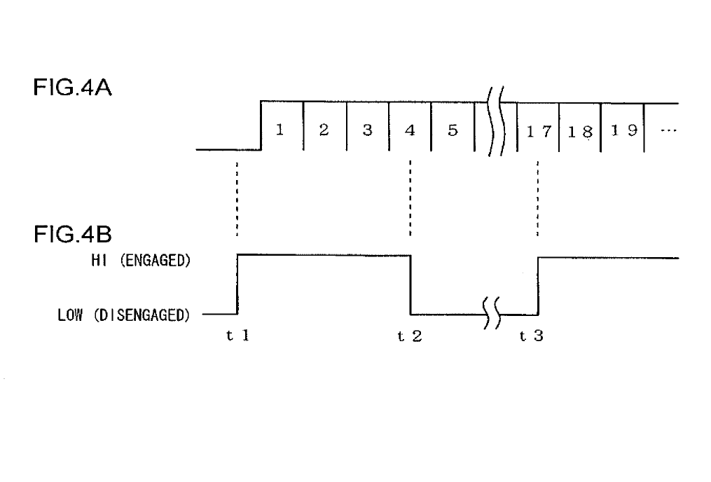

FIGS. 4A and 4B illustrate image data that may be stored into the buffer memory 29 based upon image signals output from the image sensor 24. FIG. 4A shows sets of image data 1, 2, 3, 4, 5, . . . , 17, 18, 19, . . . , respectively corresponding to frames 1, 2, 3, 4, 5, . . . 17, 18, 19, . . . , constituting a movie image, successively stored by the image sensor 24 into the buffer memory 29 as time elapses following the start of movie recording operation. FIG. 4B shows the status of the detection signal output from the lens disengagement detection unit 36. The detection signal output from the lens disengagement detection unit 36 assumes Hi level (engagement detection signal) when a lens unit 2 is mounted and assumes Low level (disengagement detection signal) when no lens unit 2 is mounted. It is to be noted that FIGS. 4A and 4B share the same time axis.

In the example presented in FIGS. 4A and 4B, the movie recording operation starts at a time point that occurs after a time point t1 at which a lens unit 2 is mounted, and the lens unit 2 is disengaged during the period of time elapsing between time points t2 and t3. Under these circumstances, the images corresponding to the sets of image data 4˜17, which are stored into the buffer memory 29 during the period of time elapsing between time points t2 and t3, are not brought up on display at the rear-side monitor 7, nor are the sets of image data 4˜17 recorded into the storage medium 31. FIG. 4A shows the set of image data 3 corresponding to frame 3 stored as the image data (most recently obtained data) obtained immediately before the disengagement of the lens unit 2. Assuming that the menu option (1-1) for displaying at the rear-side monitor 7 the image corresponding to the most recently obtained data, stored in the buffer memory 29, as the specific image has been selected in the display setting menu explained earlier and that the menu option (2-1) for recording specific image data into the storage medium 31 has been selected in the recording setting menu, the image corresponding to the image data 3 is held on display at the rear-side monitor 7 as the specific image. In addition, the image data 3 are continuously recorded into the storage medium 31.

Once a lens unit 2 is mounted at the lens mount 1a at time point t3, the control unit 21 allows images to be displayed at the rear-side monitor 7 based upon image signals output from the image sensor 24 and the corresponding image data to be recorded into the storage medium 31. Namely, the control unit 21 executes control so as to display the images corresponding to the sets of image data 18 and 19 in FIG. 4A at the rear-side monitor 7 and to record the sets of image data 18 and 19 into the storage medium 31. Under these circumstances, the control unit 21 records information (lens engagement information) indicating that no lens unit 2 was mounted at the lens mount 1a during the time period elapsing between time points t2 and t3 into, for instance, an additional information segment of the movie image file. It is to be noted that information (photographing time information) indicating the time points at which the individual sets of image data 1˜3, 18 and 19 were obtained is also recorded into the additional information segment of the movie image file.

If the menu option (2-2) for not recording any image data into the storage medium 31 has been selected in the recording setting menu, recording of the sets of image data 4˜17 into the storage unit 31 is prohibited. Then, once the lens disengagement detection unit 36 detects the presence of a lens unit 2 at the lens mount 1a at time point t3, the control unit 21 allows the image data corresponding to image signals obtained at the image sensor 24 to be recorded into the storage medium 31. Namely, the control unit 21 executes control so as to record the sets of image data 18 and 19 obtained after time point t3 into the storage medium 31. In this situation, the control unit 21 records the sets of image data 1˜3 obtained during the period of time elapsing between time points t1 and t2 and the sets of image data 18 and 19 obtained after time point t3 into a single movie image file. The control unit 21 also records information (lens engagement information) indicating that no lens unit 2 was present at the lens mount 1a during the period of time elapsing between time points t2 and t3 and photographing time information indicating the time points at which image the data were obtained into, for instance, into the additional information segment or the like of the movie image file.

It is to be noted the control unit 21 may record the sets of image data 1˜3 and the sets of image data 18 and 19 into separate movie image files instead. In such a case, the control unit 21 should record into the storage medium 31 data correlating the movie image file having the sets of image data 1˜3 recorded therein with movie image file having the sets of image data 18 and 19 recorded therein.

After displaying the image and recording image data in conformance to the settings selected in advance in the display setting menu and the recording setting menu as described above, the control unit 21 makes a decision (see S9 in FIG. 3) as to whether or not the photographer has operated the shutter button 3 again in order to end the movie recording operation. If an affirmative (“YES”) decision is made, the control unit 21 ends the movie shooting processing. If, on the other hand, the shutter button 3 has not been operated and a negative (“NO”) decision is made in S9 accordingly, the control unit 21 makes a decision as to whether or not a lens unit 2 is mounted, i.e., whether or not a lens unit 2 is present at the lens mount 1a from which a previous lens unit 2 has been disengaged, based upon the detection signal provided from the lens disengagement detection unit 36 (S10). If a negative (“NO”) decision is made, the processing returns to S8 and the processing in S8˜S10, explained earlier, is repeatedly executed. If, on the other hand, a lens unit 2 is detected at the lens mount 1a from which a previous lens unit 2 has been disengaged and accordingly an affirmative (“YES”) decision is made in S10, the processing returns to S5 and the movie shooting processing explained earlier is repeatedly executed.

The movie image corresponding to the movie image file, having been generated in the digital camera 1 and recorded into the storage medium 31 as described above, can be reproduced at an external device such as a reproduction device (e.g., a personal computer) by connecting the storage medium 31 with the reproduction device. It is to be noted that provided that the digital camera 1 is equipped with an interface (e.g., a USB interface cable or a wireless transmission path) enabling it to engage in a specific type of communication with the external device, the movie image file recorded in the storage medium 31 may be transmitted via the interface.

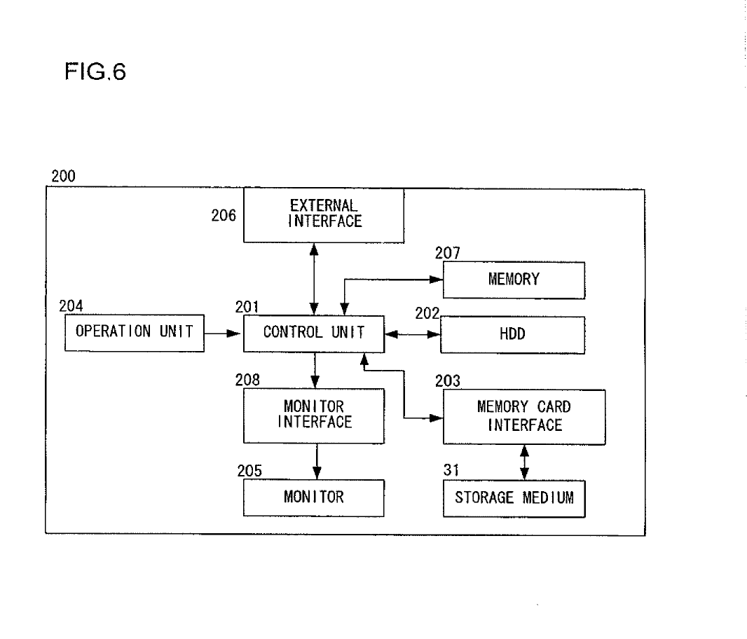

FIG. 6 is a schematic control block diagram representing a typical reproduction device 200 (e.g., a personal computer). The reproduction device 200 includes a control unit 201, an HDD 202, a memory card interface 203, an operation unit 204 constituted with a mouse, a keyboard and the like, a monitor 205, an external interface 206, a memory 207 and a monitor interface 208. The control unit 201 executes specific arithmetic operations by using signals input thereto from the various blocks and outputs control signals generated based upon the arithmetic operation results to the individual blocks. Various types of image files including movie image files obtained at the digital camera 1 are stored in the HDD 202. The external interface 206 is engaged in data communication with the digital camera 1 or the like via a specific cable, wireless transmission path or the like. The reproduction device 200 takes in an image file originating from the storage medium 31 or an external device via the memory card interface 203 or the external interface 206. The image file having been input to the reproduction device 200 is recorded into the HDD 202 by the control unit 201.

The user starts up an image reproduction software program to reproduce and display at the reproduction device 200 the movie image corresponding to a movie image file having been obtained in the digital camera 1 as described earlier. The image reproduction software program is recorded in a memory (not shown) within the control unit 201 of the reproduction device 200. In response to an image reproduction software program startup instruction issued by the user by operating the operation unit 204, the control unit 201 starts up the image reproduction software program. Once the image reproduction software program is started up, the control unit 201 reads out the movie image data in the movie image file recorded in the HDD 202 into the memory 207. Or if the movie image file is recorded in the storage medium 31 loaded at the reproduction device 200, the control unit 201 reads the movie image data in the movie image file in the storage medium 31 via the memory card interface 203 into the memory 207.

The control unit 201 then outputs the movie image data having been read out to the monitor interface 208 and thus displays a reproduced movie image at the monitor 205. At this time, the control unit 201 prohibits display, at the monitor 205, of the movie image corresponding to the image data (disengagement-period data) having been recorded in the storage medium 31 while no lens unit 2 was mounted at the digital camera 1, included in the movie image data. Namely, the control unit 201 prohibits display of the image corresponding to the specific image data (most recently obtained data or black image data) having been recorded into the storage medium 31 in correspondence to the menu option (2-1) for recording specific image data into the storage medium 31 having been selected at the digital camera 1 in the recording setting menu.

In addition, the control unit 201 outputs to the monitor interface 208 the most recently obtained image data (image data 3 shown in FIG. 4A) obtained immediately before the disengagement of the lens unit 2 from the digital camera 1 so as to continue the display of image 3 upon the monitor 205. Or the control unit 201 outputs the black image data to the monitor interface 208 so as to change the display of the movie image to the black image upon the monitor 205 or make the monitor 205 black-outs.

In addition, if the movie image file contains the set of image data 1˜3 and the sets of image data 18 and 19, as has been described in reference to FIGS. 4A and 4B, the control unit 201 brings up on display the images corresponding to the image data 1 through the image data 3 and then displays the images corresponding to the image data 18 and the image data 19. Namely, based upon the photographing time information and the lens engagement information recorded in the additional information segment of the movie image file, the control unit 201 makes a decision as to whether or not there are any sets of image data such as the sets of image data 18 and 19, having been obtained following time point t3. If it is decided that there are image data obtained after a lens unit 2 is mounted at the digital camera 1, the control unit 201 outputs those image data to the monitor interface 208 so as to display at the monitor 205 the movie image shot after a lens unit 2 was mounted. At this time, the control unit 201 outputs the image data 18 to the monitor interface 208 in succession to the image data 3. As a result, the movie image shot before the lens unit 2 was disengaged from the digital camera 1 and the movie image shot after a lens unit 2 was mounted at the digital camera 1 are displayed as a seamless movie sequence at the monitor 205.

The following advantages are achieved through the embodiment described above.

(1) As a lens unit 2 is disengaged from the lens mount 1a at the body of the digital cameral and the communication between the lens unit 2 and the body of the digital camera 1 is thus interrupted while a movie shooting operation is in progress, the lens disengagement detection unit 36 detects removal of the lens unit 2 from the body of the digital camera 1 at the point in time at which the communication becomes interrupted. Once the disengagement of the lens unit 2 is detected by the lens disengagement detection unit 36, display at the rear-side monitor 7 of any image based upon image signals obtained at the image sensor 24 following the disengagement of the lens unit 2 is prohibited (see S8 In FIG. 3). Thus, no disrupted movie image is displayed at the rear-side monitor 7 even if the lens unit 2 is disengaged from the body of the digital camera 1 while the movie shooting operation is in progress and, as a result, the photographer is able to view a stable display at the rear-side monitor 7.

(2) As the lens disengagement detection unit 36 detects the absence of a lens unit 2 at the lens mount 1a, the control unit 21 brings up on display at the rear-side monitor 7 a specific image and executes control for image data recording at the storage unit 31 (see S8 in FIG. 3) based upon the options having been selected in the display setting menu and the recording setting menu. Thus, even when a lens unit 2 is disengaged from the body of the digital camera 1 while the movie shooting operation is in progress, a specific image desired by the photographer is brought up on display at the rear-side monitor 7 instead of the unstable movie image, which would disconcert the photographer.

(3) A specific image, which is based upon the most recently obtained data having been stored into the buffer memory 29 immediately before the lens disengagement detection unit 36 detects disengagement of the lens unit 2 from the lens mount 1a, is displayed at the rear-side monitor 7 based upon a selected specific menu option in the display setting menu. In this case, the image corresponding to the image data obtained immediately before the disengagement of the lens unit 2 is held on display at the rear-side monitor 7 continuously even after the lens unit 2 is disengaged. As a result, even after the disengagement of the lens unit 2, a movie image no different from that having been on display at the rear-side monitor 7 is held on display.

(4) As the lens disengagement detection unit 36 detects disengagement of the lens unit 2, recording at the storage medium 31 of image data expressing any image captured at the image sensor 24 following the disengagement of the lens unit 2 and stored into the buffer memory 29 is prohibited (see S8 in FIG. 3). Consequently, even if the lens unit 2 is disengaged from the digital camera 1 while a movie shooting operation is in progress, no disruption of the movie image occurs in the display at the rear-side monitor 7 and thus, the photographer will not be bothered by a disrupted movie image. In addition, the image data corresponding to such a movie image are not recorded into the storage medium 31.

(5) A movie shooting operation interrupted for photographing lens replacement needs to be resumed after the replacement lens is fully mounted in the related art. Since the camera must be restarted to resume the movie shooting operation, the length of time over which the movie shooting operation is interrupted is bound to be significant. In contrast, the digital camera 1 achieved in the embodiment allows the lens unit 2 to be replaced without having to interrupt the movie shooting operation and thus, the length of time over which the movie shooting operation needs to be interrupted for the replacement of the lens unit 2 can be minimized. In addition, since the digital camera has a function of recording sound during the movie shooting operation through the microphone 5, sound can be continuously recorded even as the lens unit 2 is being replaced.

(6) At the monitor 205 of the reproduction device 200, to which movie image data having been obtained at the digital camera 1 are input, the movie image corresponding to the movie image data having been input are displayed. The control unit 201 detects the part of the input movie image data, which was obtained while the lens unit 2 was disengaged from the digital camera 1 as disengagement-period data and prohibits display of the movie image corresponding to the disengagement-period data at the monitor 205. Consequently, any movie image destabilized due to noise or the like is not displayed at the monitor 205.

The embodiment described above allows for the following variations.

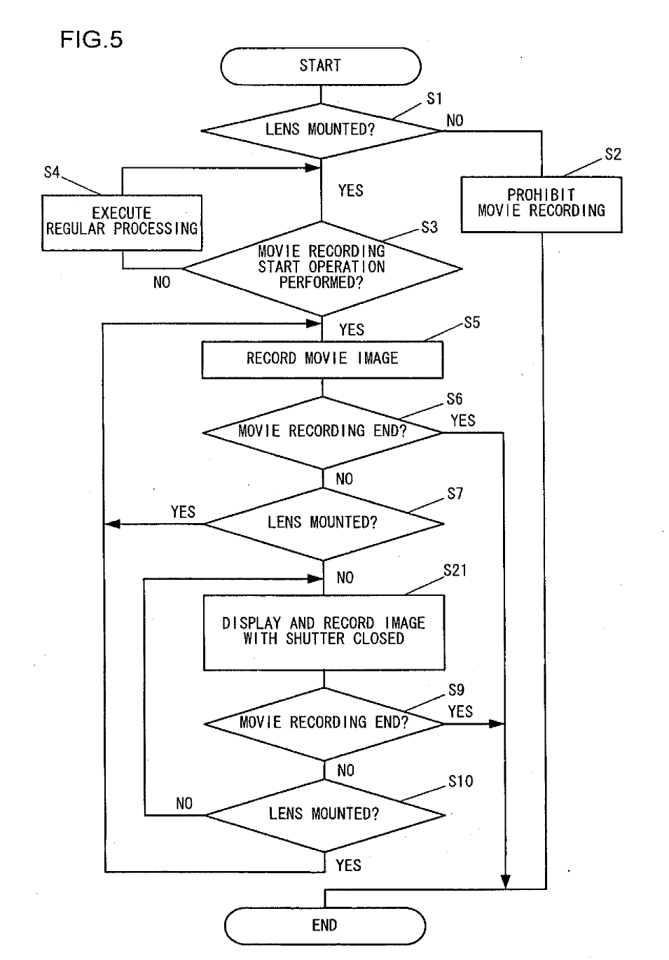

(1) The black image data used to display a black image at the rear-side monitor 7 as the specific image and recorded into the storage medium 31 in correspondence to the settings selected in the display setting menu and the recording setting menu do not need to be black image data readout from the internal memory holding the black image data recorded in advance. For instance, as the option for displaying or recording a black image as the specific image is selected in the display setting menu or the recording setting menu, the mechanical shutter may be closed and black image data obtained at the image sensor 24 in this state may be taken in, as shown in a movie shooting processing flowchart presented in FIG. 5.

The movie shooting processing in FIG. 5 is identical to the movie shooting processing executed in the embodiment having been described in reference to FIG. 3 except for details of the processing executed in S21 in correspondence to the options for displaying and recording a black image as the specific image, having been selected in advance in the display setting menu and the recording setting menu, as described above. It is to be noted that in FIG. 5 the same step numbers are assigned to steps in which processing identical to that in FIG. 3 is executed so as to preclude the necessity for a repeated explanation.

In the movie shooting processing in FIG. 5, if a negative (“NO”) decision is made in S7 with regard to whether or not a lens unit 2 is mounted, the control unit 21 closes the mechanical shutter in S21 and continuously uses the image taken in from the image sensor 24 for display at the rear-side monitor 7 and for recording into the storage medium 31. With the mechanical shutter closed, the subject light having passed through the lens 2a is blocked by the mechanical shutter and thus does not reach the image sensor 24. As a result, a black image similar to the black image used in the embodiment is brought up on display at the rear-side monitor 7 and the black image data taken in from the image sensor 24 are recorded into the storage medium 31.

This alternative configuration achieves advantages similar to those of the embodiment described earlier and further achieves an added advantage in that since the mechanical shutter is closed while the lens unit 2 is absent, dust and the like do not settle on the image sensor 24.

(2) While sound picked up through the microphone 5 is also recorded during the movie shooting operation in the embodiment described above, it is not essential that sound be recorded during the movie shooting operation.

(3) The specific image displayed at the rear-side monitor 7 while the lens unit 2 is disengaged does not need to be a still image, or the specific image data recorded into the storage medium 31 while the lens unit 2 is disengaged do not need to express a still image. For instance, a movie image expressed with any image data selected by the photographer from image data corresponding to movie image already captured and recorded in the storage medium 31 may be brought up on display as the specific image at the rear-side monitor 7 or the image data selected by the photographer as described above may be recorded into the storage medium 31.

(4) The movie shooting processing in FIG. 3 does not need to continue (see S7˜S10 in FIG. 3) while the lens unit 2 remains disengaged from the lens mount 1a. For instance, after a negative (“NO”) decision is made in S7 and the lens unit 2 remains disengaged from the lens mount 1a over a length of time exceeding a predetermined length of time, the movie shooting processing may end automatically.

(5) The power to the rear-side monitor 7 may be turned off instead of displaying the specific image at the rear-side monitor 7 while the lens unit 2 is disengaged. While this configuration allows the image data expressing the disrupted image, which are temporarily stored in the buffer memory 29, to be output to the rear-side monitor 7, the disrupted image is not brought up on display at the rear-side monitor 7.

(6) While a description is given in reference to the embodiment on an example in which the image corresponding to the most recently obtained data stored in the buffer memory 29 is brought up on display after the lens unit 2 is disengaged in conformance to the specific option selected in the display setting menu, the present invention is not limited to this example. For instance, after the lens unit 2 is disengaged, the image corresponding to the last set of image data recorded into the storage medium 31 prior to the disengagement of the lens unit 2 may be brought up on display at the rear-side monitor 7.

(7) While the description provided above focuses on the control executed by the control unit 21 when the movie shooting mode is selected in response to an operation of the photographing mode dial 4, similar control may be executed in a mode other than the movie shooting mode. For instance, the control unit 21 may executed similar control on the image brought up on display at the rear-side monitor 7 in a live view mode. In the live view mode, the quick-return mirror (not shown) is swung upward prior to a shutter release to provide at the rear-side monitor 7 a real-time display of images corresponding to image signals obtained at the image sensor 24 without recording any image data into the storage medium 31. As the lens disengagement detection unit 36 detects engagement of a lens unit 2 at the lens mount 1a in this mode, the control unit 21 starts executing control via the rear-side monitor interface 32 for displaying at the rear-side monitor 7 images based upon image signals obtained at the image sensor 24. Then, as long as the lens disengagement detection unit 36 detects the absence of the lens unit 2 from the lens mount 1a, the control unit 21 prohibits display at the rear-side monitor 7 of images based upon image signals output from the image sensor 24. While no lens unit 2 is detected, the control unit 21 holds the image corresponding to the most recently obtained data or the black image data described earlier on display at the rear-side monitor 7. It is to be noted that the control unit 21 and the storage medium interface 30 do not execute control for recording image data based upon the image signals obtained at the image sensor 24 into the storage medium 31 in the live view mode.

(8) The reproduction device 200 may be any of various devices other than a personal computer, as long as image files can be input thereto. In addition, the present invention may be adopted in conjunction with image files input from a device other than a camera.

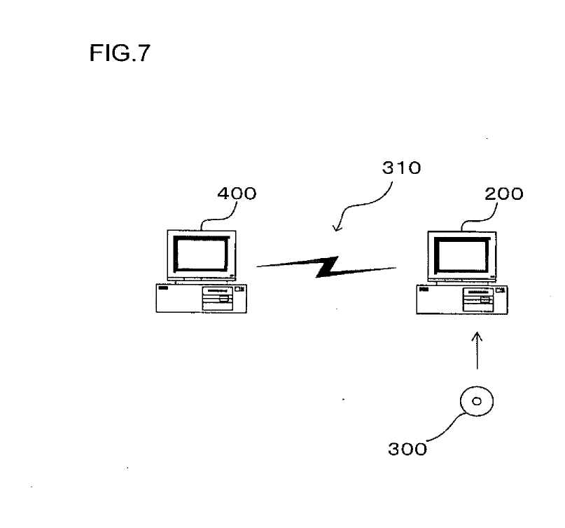

The program enabling the control described above may be provided in a recording medium such as a CD-ROM or through a data signal carried on, for instance, the Internet. FIG. 7 shows how the program may be actually provided. The reproduction device 200 receives the program via a CD ROM 300. The reproduction device 200 is capable of connecting with a communication line 310. A computer 400 is a server computer that provides the program stored in a recording medium such as a hard disk. The communication line 310 may be a communication network such as the Internet or another personal computer communication network, or it may be a dedicated communication line. The computer 400 reads out the program from the hard disk and transmits the program to the reproduction device 200 via the communication line 310. Namely, the program, embodied as a data signal on a carrier wave, is transmitted via the communication line 310. In other words, the program may be distributed as a computer-readable computer program product adopting any of various modes including a recording medium and a carrier wave.

Advantages similar to those of the embodiment described earlier are achieved by adopting any of the alternative structures described above.

The above described embodiment is an example and various modifications can be made without departing from the scope of the invention.

What is claimed is:

1. An imaging device, comprising:
a mount unit at which an optical system can be mounted;
a detection unit that detects disengagement of the optical system from the mount unit;
an imaging unit that captures a subject image formed via the optical system mounted at the mount unit and outputs image signals;
a display unit at which an image is brought up on display based upon the image signals output from the imaging unit; and
a control unit that prohibits display of the image at the display unit, the image being based upon the image signals output from the imaging unit after the detection unit detects disengagement of the optical system.

2. An imaging device according to claim 1, wherein:
the detection unit also detects engagement of the optical system at the mount unit; and
if the detection unit detects engagement of the optical system while display of the image based upon the image signal at the display unit is prohibited, the control unit issues permission for displaying at the display unit an image that is based upon the image signals output from the imaging unit after engagement of the optical system is detected.

3. An imaging device according to claim 1, wherein:
if the detection unit detects disengagement of the optical system, the control unit executes control so as to display a specific image at the display unit.

4. An imaging device according to claim 3, further comprising:
a temporary storage unit where image signals output from the imaging unit are temporarily stored, wherein:
the control unit executes control so as to display at the display unit an image based upon image signals as the specific image, the image signals having been stored into the temporary storage unit before the detection unit detects disengagement of the optical system.

5. An imaging device according to claim 1, further comprising:
a recording control unit that records image signals output from the imaging unit into a storage medium as first movie image data, wherein:
the recording control unit prohibits recording at the storage medium of image signals that are output from the imaging unit after the detection unit detects disengagement of the optical system.

6. An imaging device according to claim 5, wherein:
the detection unit also detects engagement of the optical system at the mount unit; and
if the detection unit detects engagement of the optical system while recording at the storage medium of the image signals output from the imaging unit is prohibited, the recording control unit records into the storage medium image signals as second movie image data, the image signal being output from the imaging unit after engagement of the optical system is detected.

7. An imaging device according to claim 6, wherein:
the recording control unit records the first movie image data and the second movie image data into a single image file.

8. An imaging device according to claim 6, wherein:
the recording control unit records the first movie image data and the second movie image data into separate image files.

9. An imaging device, comprising:
a mount unit at which an optical system can be mounted;
a detection unit that detects engagement of the optical system at the mount unit;
an imaging unit that captures a subject image formed via the optical system mounted at the mount unit and outputs image signals;
a display unit at which an image is brought up on display based upon image signals output from the imaging unit; and
a control unit that brings up on display at the display unit an image based upon the image signals output from the imaging unit, when the detection unit detects engagement of the optical system.

10. A reproduction device, comprising:
an input unit that takes in movie image data having been obtained at an imaging device;
a display unit at which a movie image corresponding to the movie image data input via the input unit is displayed;
a detection unit that detects movie image data among the input movie image data as disengagement-period data, the movie image data being obtained at the imaging device while no optical system was present at a mount unit of the imaging device; and
a control unit that prohibits display at the display unit of a movie image corresponding to the disengagement-period data if the detection unit detects the disengagement-period data.

11. A reproduction device according to claim 10, wherein:
the control unit brings up on display at the display unit a movie image corresponding to image data included in the movie image data input via the input unit, the image data being obtained after acquisition of the disengagement-period data detected by the detection unit.

12. A reproduction device according to claim 11, wherein:
the control unit brings up on display at the display unit movie image corresponding to movie image data included in the movie image data input via the input unit as a seamless movie sequence, the movie image data excluding the disengagement-period data detected by the detection unit.

13. A computer-readable recording medium on which an image reproduction program that is executed by a computer is recorded, the image reproduction program comprising;
an input procedure through which movie image data obtained at an imaging device are input;
a display procedure through which a movie image corresponding to the movie image data having been input is brought up on display at a display unit;
a detection procedure through which movie image data included in the input movie image data are detected as disengagement-period data, the movie image data being obtained at the imaging device while no optical system was mounted at a mount unit of the imaging device; and
a control procedure through which display at the display unit of a movie image corresponding to the disengagement period data is prohibited if the disengagement-period data are detected.
